(19) United States
(12) Patent Application Publication
(10) Pub. No.: US 2015/0146034 A1
(43) Pub. Date: May 28, 2015

(54) SOLID-STATE IMAGING DEVICE AND DIGITAL CAMERA

(71) Applicant: Kabushiki Kaisha Toshiba, Minato-ku (JP)

(72) Inventors: Takayuki OGASAHARA, Yokohama (JP); Ken TANABE, Ota (JP); Katsuo IWATA, Yokohama (JP); Kazuhiro NAGATA, Yokohama (JP); Ninao SATO, Mitaka (JP)

(73) Assignee: Kabushiki Kaisha Toshiba, Minato-ku (JP)

(21) Appl. No.: 14/459,562

(22) Filed: Aug. 14, 2014

(30) Foreign Application Priority Data
Nov. 25, 2013 (JP) 2013-243260

(51) Int. Cl. H04N 9/30; H04N 5/369

(52) U.S. Cl. CPC H04N 9/30; H04N 5/369
USPC 348/222.1

(57) ABSTRACT

According to one embodiment, a solid-state imaging device includes a demosaic processing unit. A pixel block includes a red pixel, a blue pixel, a first green pixel, and a second green pixel. A first green component detected by the first green pixel and a second green component detected by the second green pixel are green components of the same wavelength region. The demosaic processing unit generates image signals of four components. The four components are a red component, a blue component, the first green component, and the second green component.

### CROSS-REFERENCE TO RELATED APPLICATIONS

This application is based upon and claims the benefit of priority from Japanese Patent Application No. 2013-243260, filed on Nov. 25, 2013; the entire contents of which are incorporated herein by reference.

### FIELD

Embodiments described herein relate generally to a solid-state imaging device and a digital camera.

### BACKGROUND

In the past, a Bayer array has been generally employed as a color array of an image sensor that is included in a solid-state imaging device. The Bayer array uses a 2×2 pixel block as a unit. A red (R) pixel and a blue (B) pixel are disposed at diagonally opposite corners of the pixel block, and two green (G) pixels are disposed at the rest of diagonally opposite corners of the pixel block. The G pixel, which is adjacent to the R pixel in a row direction, of the two G pixels, which are included in the pixel block, is referred to as a Gr pixel. The G pixel, which is adjacent to the B pixel in the row direction, of the two G pixels, which are included in the pixel block, is referred to as a Gb pixel.

There is, for example, optical or electrical crosstalk (color mixture), which occurs between adjacent pixels, as a cause that makes the color reproducibility of the image sensor deteriorate. The pixel size of the image sensor is reduced so that the image sensor copes with the reduction of the size of the camera module and the increase of the number of pixels. Crosstalk easily occurs with the reduction of pixel size.

Further, a difference in light sensitivity between adjacent pixels may occur due to, for example, light reflected from a wiring layer of a photodiode. When the amount of light reflected from the wiring layer is not even due to the symmetry of the structure of the photodiode or the like, a difference in sensitivity may occur between adjacent pixels. For example, in a photodiode including wiring formed on the back thereof, an influence of the light, which is reflected from the wiring formed on the back, is increased with the reduction of the thickness of a silicon layer formed on the wiring formed on the back.

When a difference in sensitivity occurs between the Gr pixel and the Gb pixel due to these causes, luminance unevenness, which is not present on an object, may appear on an image in the shape of, for example, a lattice. An image sensor, which performs processing for averaging a signal output from the Gr pixel and a signal output from the Gb pixel in order to reduce luminance unevenness caused by the difference in sensitivity between the Gr pixel and the Gb pixel, has been known in the past. However, since the image sensor performs the processing for averaging signals, the resolution of an image is significantly lowered.

When a difference in sensitivity between the pixels is to be reduced through the review of the structure of the photodiode, a balance between the reduction of a difference in sensitivity and other characteristics of the photodiode needs to be considered. For this reason, development is accompanied with much difficulty.

### BRIEF DESCRIPTION OF THE DRAWINGS

FIG. 1 is a block diagram illustrating the schematic configuration of a solid-state imaging device according to an embodiment;

FIG. 2 is a block diagram illustrating the schematic configuration of a digital camera that includes the solid-state imaging device;

FIG. 3 is a diagram illustrating the schematic configuration of an optical system that is provided in the digital camera;

FIG. 4 is a diagram illustrating the array of color filters;

FIG. 5 is a diagram illustrating a pixel block that forms a Bayer array of a pixel array;

FIG. 6 is a block diagram illustrating the configuration of an ISP;

FIG. 7 is a diagram illustrating examples of conversion tables that are used to obtain signals of the respective R, B, Gr, and Gb components at the position of an R pixel;

FIG. 8 is a diagram illustrating examples of conversion tables that are used to obtain signals of the respective R, B, Gr, and Gb components at the position of a B pixel;

FIG. 9 is a diagram illustrating examples of conversion tables that are used to obtain signals of the respective R, B, Gr, and Gb components at the position of a Gr pixel;

FIG. 10 is a diagram illustrating examples of conversion tables that are used to obtain signals of the respective R, B, Gr, and Gb components at the position of a Gb pixel;

FIG. 11 is a diagram illustrating a condition of the conversion table that is used to obtain a signal of each of R, B, Gr, and Gb components at the position of an R pixel;

FIG. 12 is a diagram illustrating a condition of the conversion table that is used to obtain a signal of each of R, B, Gr, and Gb components at the position of a Gr pixel;

FIG. 13 is a diagram illustrating a condition of the conversion table that is used to obtain a signal of each of R, B, Gr, and Gb components at the position of a B pixel; and

FIG. 14 is a diagram illustrating a condition of the conversion table that is used to obtain a signal of each of R, B, Gr, and Gb components at the position of a Gb pixel.

### DETAILED DESCRIPTION

In general, according to one embodiment, a solid-state imaging device includes a pixel array and a signal processing circuit. A plurality of pixels is disposed in the pixel array in the form of an array. The pixel includes a photoelectric conversion element. The pixel array shares and detects a signal level of each color light with every pixel. The signal processing circuit performs signal processing on image signals that are output from the pixel array. The signal processing circuit includes a demosaic processing unit. The demosaic processing unit performs demosaic processing. The demosaic processing is processing for generating a signal component of each color light at the position of each pixel by interpolating signal levels detected at the respective pixels. The pixel array is formed using a pixel block as a unit. The pixel block includes a red pixel, a blue pixel, a first green pixel, and a second green pixel. The red pixel detects a signal level of red light. The blue pixel detects a signal level of blue light. The first and second green pixels detect a signal level of green light. A first green component detected by the first green pixel and a second green component detected by the second green pixel are green components of the same wavelength region. The demosaic processing unit generates image signals of four components. The four components are a red component, a blue component, and the first green component, and the second green component. The red component is detected by the red pixel. The blue component is detected by the blue pixel.

Exemplary embodiments of a solid-state imaging device and a digital camera will be explained below in detail with reference to the accompanying drawings. The present invention is not limited to the following embodiments.

### Embodiment

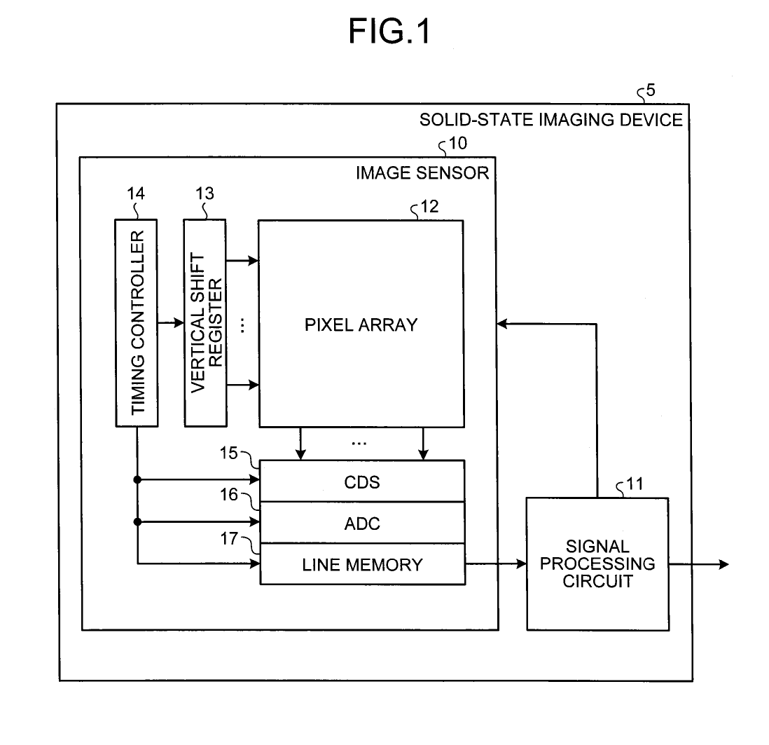

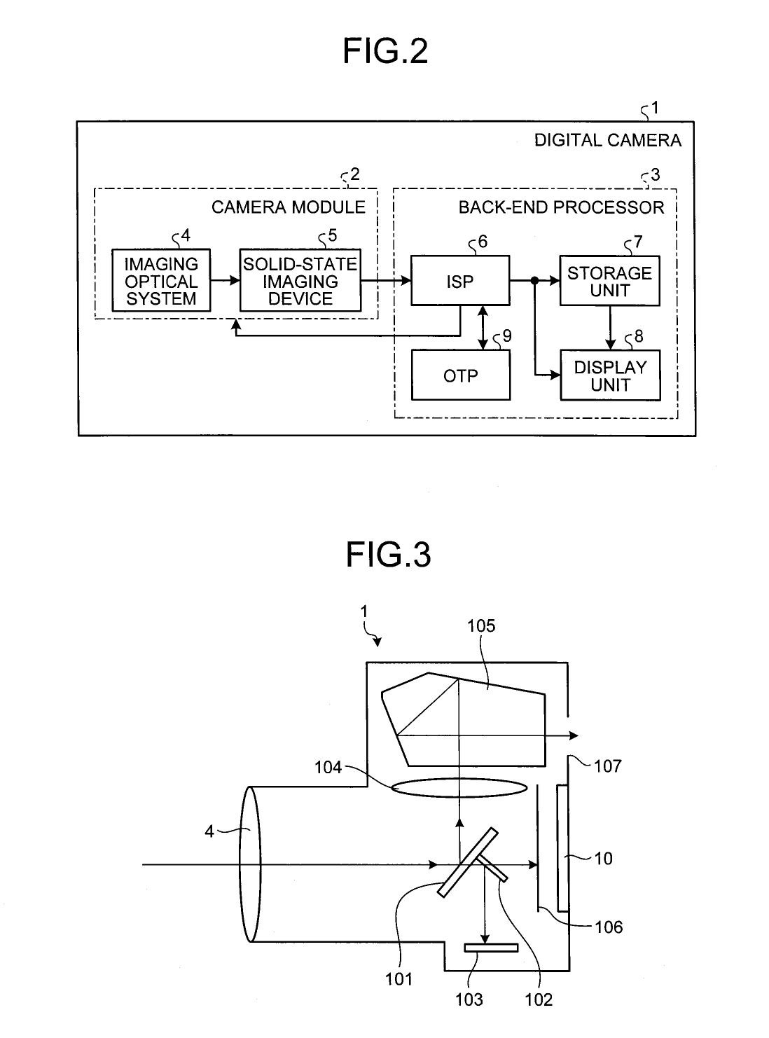

FIG. 1 is a block diagram illustrating the schematic configuration of a solid-state imaging device according to an embodiment. FIG. 2 is a block diagram illustrating the schematic configuration of a digital camera that includes the solid-state imaging device.

A digital camera 1 includes a camera module 2 and a back-end processor 3. The camera module 2 includes an imaging optical system 4 and a solid-state imaging device 5. The back-end processor 3 includes an image signal processor (ISP) 6, a storage unit 7, a display unit 8, and an OTP (one time programmable memory) 9. The configuration of the digital camera 1 according to the embodiment may be applied to an electronic device such as a portable terminal with a camera.

The imaging optical system 4 receives light from an object and forms an image of the object. The solid-state imaging device 5 takes the image of the object. The ISP 6 processes image signals that are obtained by the imaging of the solid-state imaging device 5. The ISP 6 performs signal processing, such as defect correction, noise reduction processing, lens shading correction, demosaic processing, white balance adjustment, color matrix processing, and gamma correction. The storage unit 7 stores the image that has been subjected to the signal processing performed by the ISP 6. The storage unit 7 outputs image signals to the display unit 8 according to the operation of a user or the like.

The display unit 8 displays an image according to image signals that are input from the ISP 6 or the storage unit 7. The display unit 8 is, for example, a liquid crystal display. The digital camera 1 performs the feedback control of the camera module 2 on the basis of data that have been subjected to the signal processing performed by the ISP 6. The OTP 9 stores parameters that are used for the signal processing performed by the ISP 6.

The solid-state imaging device 5 includes an image sensor 10 that is an imaging element and a signal processing circuit 11 that is an image processing unit. The image sensor 10 is, for example, a CMOS image sensor. The image sensor 10 may be a CCD other than the CMOS image sensor.

The image sensor 10 includes a pixel array 12, a vertical shift register 13, a timing controller 14, a correlation double sampling unit (CDS) 15, an analog-to-digital converter (ADC) 16, and a line memory 17.

The pixel array 12 is provided in an imaging region of the image sensor 10. The pixel array 12 is formed of a plurality of pixels that are disposed in the form of an array in a horizontal direction (row direction) and a vertical direction (column direction). Each of the pixels includes a photodiode that is a photoelectric conversion element. The photodiode generates signal charges corresponding to the amount of incident light. The pixel array 12 shares and detects a signal level of each color light with every pixel according to a color array.

The timing controller 14 supplies a vertical synchronization signal, which indicates timing where a signal output from each pixel of the pixel array 12 is read out, to the vertical shift register 13. The timing controller 14 supplies a timing signal, which indicates drive timing, to each of the CDS 15, the ADC 16, and the line memory 17.

The vertical shift register 13 selects the pixels of the pixel array 12 for each row according to the vertical synchronization signal supplied from the timing controller 14. The vertical shift register 13 outputs a readout signal to each pixel of the selected row. The pixel to which the readout signal is input from the vertical shift register 13 outputs signal charges that are accumulated according to the amount of incident light. The pixel array 12 outputs the signals, which are output from the pixels, to the CDS 15 through a vertical signal line.

The CDS 15 performs correlation double sampling processing, which reduces fixed pattern noise, on the signals output from the pixel array 12. The ADC 16 converts an analog signal into a digital signal. The line memory 17 accumulates signals that are output from the ADC 16. The image sensor 10 outputs the signals that are accumulated in the line memory 17.

The signal processing circuit 11 performs various kinds of signal processing on the image signals that are output from the image sensor 10. The solid-state imaging device 5 outputs the image signals, which has been subjected to the signal processing performed by the signal processing circuit 11, to the outside of a chip. The solid-state imaging device 5 performs the feedback control of the image sensor 10 on the basis of data that have been subjected to the signal processing performed by the signal processing circuit 11.

FIG. 3 is a diagram illustrating the schematic configuration of an optical system that is provided in the digital camera. Light, which is incident on the imaging optical system 4 of the digital camera 1 from an object, travels to the image sensor 10 through a main mirror 101, a sub-mirror 102, and a mechanical shutter 106. The digital camera 1 takes the image of an object on the image sensor 10.

Light, which is reflected by the sub-mirror 102, travels to an autofocus (AF) sensor 103. The digital camera 1 performs focus adjustment that uses a detection result of the AF sensor 103. Light, which is reflected by the main mirror 101, travels to a finder 107 through a lens 104 and a prism 105.

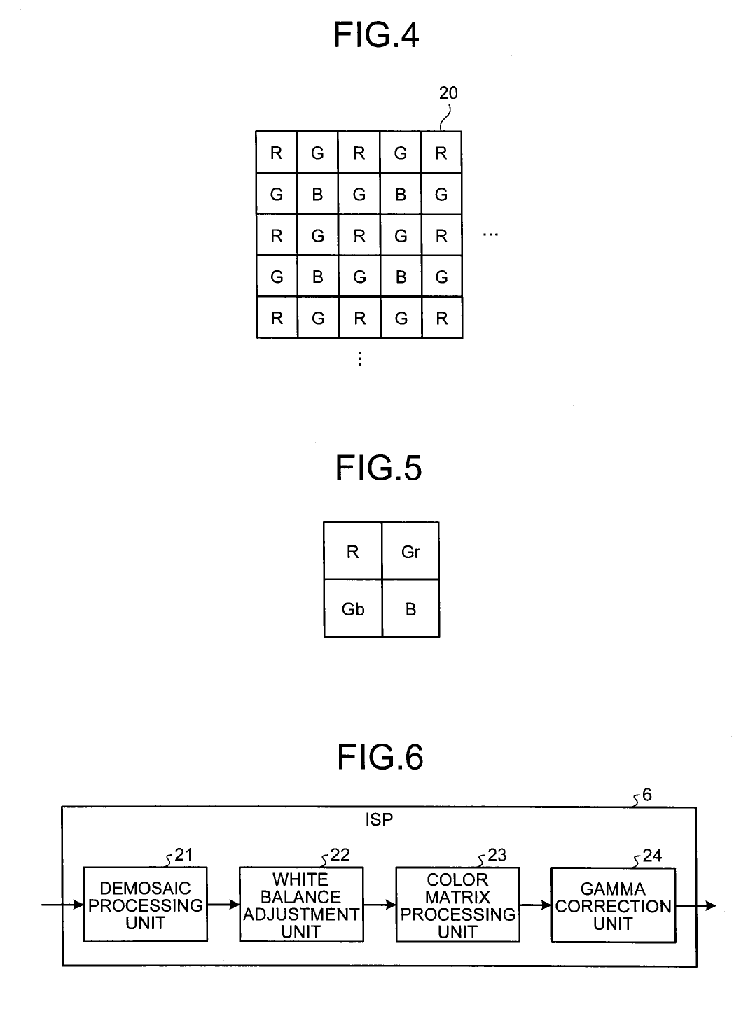

FIG. 4 is a diagram illustrating the array of color filters. FIG. 5 is a diagram illustrating a pixel block that forms a Bayer array of the pixel array. Color filters 20 are provided on the incident sides of the respective pixels of the pixel array 12.

Red (R) pixels, blue (B) pixels, and green (G) pixels of the pixel array 12 are disposed according to the Bayer array. An R pixel detects the signal level of R light. A B pixel detects the signal level of B light. A G pixel detects the signal level of G light.

The Bayer array uses a 2×2 pixel block as a unit. An R pixel and a B pixel are disposed at diagonally opposite corners of the pixel block. Two G pixels are disposed at the rest of diagonally opposite corners of the pixel block. The pixel array 12 is formed using the pixel block, which includes an R pixel, a B pixel, and two G pixels, as a unit.

A Gr pixel is the G pixel, which is adjacent to the R pixel in the row direction, of the two G pixels that are included in the pixel block. The Gr pixel is a first green pixel. A Gb pixel is the G pixel, which is adjacent to the B pixel in the row direction, of the two G pixels that are included in the pixel block. The Gb pixel is a second green pixel.

The color filter 20, which is provided on the incident side of the R pixel, selectively transmits R light. The color filter 20, which is provided on the incident side of the B pixel, selectively transmits B light. The color filter 20, which is provided on the incident side of the Gr pixel, selectively transmits G light. The color filter 20, which is provided on the incident side of the Gb pixel, selectively transmits G light.

The color filter 20, which is provided on the incident side of the Gr pixel, and the color filter 20, which is provided on the incident side of the Gb pixel, have wavelength characteristics of transmitting G light of the same wavelength region. Accordingly, the Gr pixel and the Gb pixel detect the signal levels of G light, which has passes through the respective color filters 20, of the same wavelength region.

FIG. 6 is a block diagram illustrating the configuration of the ISP. FIG. 6 illustrates structures that are used for demosaic processing, white balance adjustment, color matrix processing, and gamma correction, among structures that are used for various kinds of signal processing performed by the ISP 6. Structures, which are used for other signal processing performed by the ISP 6, are not illustrated.

Image signals, which are input to the ISP 6, are input to, for example, a demosaic processing unit 21, a white balance adjustment unit 22, a color matrix processing unit 23, and a gamma correction unit 24 in this order. The demosaic processing unit 21 performs demosaic processing for generating a signal level of each color light at the position of each pixel by interpolating signal levels that are detected at the respective pixels. The demosaic processing unit 21 synthesizes a color bitmap image by performing demosaic processing on RAW data.

The demosaic processing unit 21 performs the interpolation of the signal level that is detected by the R pixel, the signal level that is detected by the B pixel, the signal level that is detected by the Gr pixel, and the signal level that is detected by the Gb pixel. In the calculation for the interpolation, the demosaic processing unit 21 differentiates the signal level, which is detected by the Gr pixel, from the signal level, which is detected by the Gb pixel, and deals with the signal levels as in the case of the signal levels that are detected from light corresponding to colors different from each other.

The demosaic processing unit 21 generates image signals of four components, that is, R, B, Gr, and Gb components. An R image signal is formed of a signal of an R component that is detected by the R pixel and an interpolation result of R components that are obtained at the positions of the respective B, Gr, and Gb pixels. A B image signal is formed of a signal of a B component that is detected by the B pixel and an interpolation result of B components that are obtained at the positions of the respective R, Gr, and Gb pixels.

A Gr image signal is formed of a signal of a Gr component that is detected by the Gr pixel and an interpolation result of Gr components that are obtained at the positions of the respective R, B, and Gb pixels. A Gb image signal is formed of a signal of a Gb component that is detected by the Gb pixel and an interpolation result of Gb components that are obtained at the positions of the respective R, B, and Gr pixels. The Gr component, which is a first green component detected by the Gr pixel, and the Gb component, which is a second green component detected by the Gb pixel, are G light components of the same wavelength region.

The white balance adjustment unit 22 performs white balance processing on the respective color image signals that are generated by the demosaic processing. The color matrix processing unit 23 performs color matrix processing on the respective color image signals. The color matrix processing unit 23 coverts the image signals, which correspond to four components, that is, R, B, Gr, and Gb components, into image signals of three components, that is, R, B, and G components, by performing the color matrix processing. The color matrix processing unit 23 performs the adjustment of the image signal that improves color reproducibility according to the conversion of the image signal.

The gamma correction unit 24 performs gamma correction, which corrects the gradation of an image, on the R, G, and B image signals that have been subjected to the color matrix processing. Meanwhile, an order in which the image signals are input to the demosaic processing unit 21, the white balance adjustment unit 22, the color matrix processing unit 23, and the gamma correction unit 24, may be appropriately changed.

In the digital camera 1, at least one of the various kinds of signal processing that are performed in this embodiment by the ISP 6 may be performed by the signal processing circuit 11 of the solid-state imaging device 5. In the digital camera 1, at least one of the various kinds of signal processing may be performed by both the signal processing circuit 11 and the ISP 6. The signal processing circuit 11 and the ISP 6 may additionally perform signal processing other than the signal processing described in this embodiment. The signal processing circuit 11 and the ISP 6 may not perform processing, which may be omitted, among the signal processing described in this embodiment.

The demosaic processing unit 21 performs the interpolation of the signal levels on the basis of, for example, a 5×5 conversion table. The conversion table is a matrix of which elements are coefficients to be multiplied by signal levels of the respective pixels included in the 5×5 pixel block.

The conversion table is stored in, for example, the OTP 9 in advance. The OTP 9 is a storage unit that stores conversion tables. The OTP 9 stores sixteen conversion tables that are used to obtain signals of the respective R, B, Gr, and Gb components at the positions of the respective R, B, Gr, and Gb pixels. Conversion tables, which are different from each other, are prepared in the OTP 9 as a conversion table that is used to obtain a Gr component and a conversion table that is used to obtain a Gb component. The demosaic processing unit 21 reads out the conversion tables from the OTP 9.

Each coefficient of each conversion table is set so as to include the adjustment for reducing a difference in sensitivity between a Gr pixel and a Gb pixel. The respective set coefficients of the respective conversion tables, which are used to obtain an R component and a B component in this embodiment, are different from the respective set coefficients of a case in which a signal level detected by a Gr pixel and a signal level detected by a Gb pixel are dealt with without being differentiated from each other.

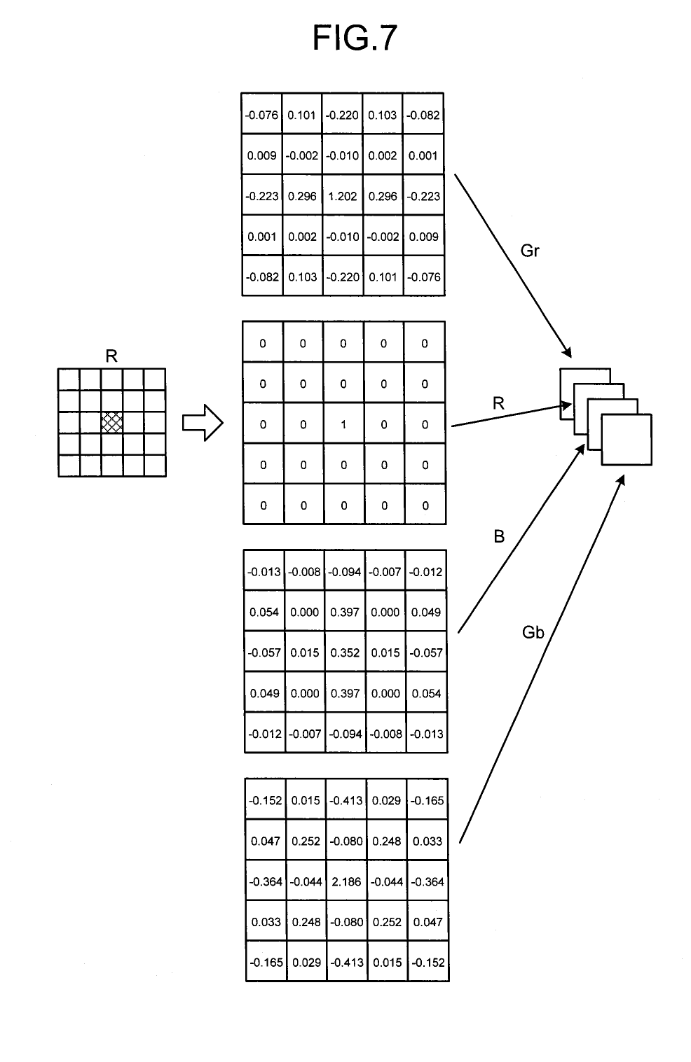

FIG. 7 is a diagram illustrating examples of conversion tables that are used to obtain signals of the respective R, B, Gr, and Gb components at the position of an R pixel. An R pixel is positioned at the center of the 5×5 pixel block. The demosaic processing unit 21 may output the signal level, which is detected by the R pixel, as it is, as for a signal of the R component at the R pixel. The demosaic processing unit 21 performs interpolation, which is based on the conversion tables prepared for the respective B, Gr, and Gb components, on the respective B, Gr, and Gb components at the position of the R pixel.

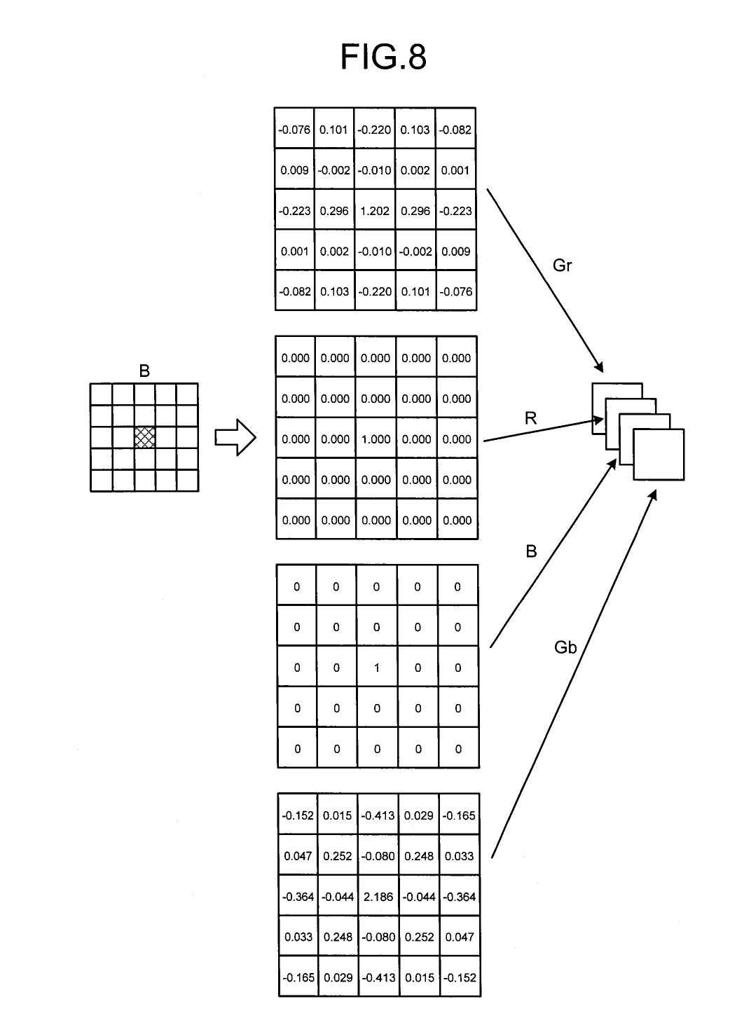

FIG. 8 is a diagram illustrating examples of conversion tables that are used to obtain signals of the respective R, B, Gr, and Gb components at the position of a B pixel. A B pixel is positioned at the center of the 5×5 pixel block. The demosaic processing unit 21 may output the signal level, which is detected by the B pixel, as it is, as for a signal of the B component at the B pixel. The demosaic processing unit 21 performs interpolation, which is based on the conversion tables prepared for the respective R, Gr, and Gb components, on the respective R, Gr, and Gb components at the position of the B pixel.

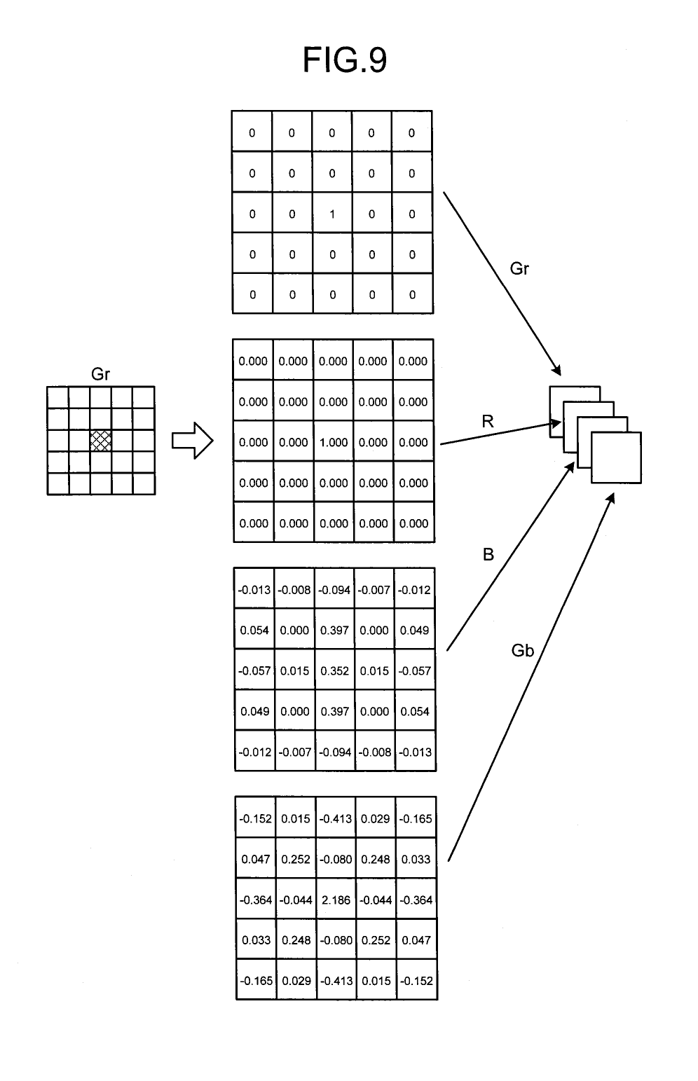

FIG. 9 is a diagram illustrating examples of conversion tables that are used to obtain signals of the respective R, B, Gr, and Gb components at the position of a Gr pixel. A Gr pixel is positioned at the center of the 5×5 pixel block. The demosaic processing unit 21 may output the signal level, which is detected by the Gr pixel, as it is, as for a signal of the Gr component at the R pixel. The demosaic processing unit 21 performs interpolation, which is based on the conversion tables prepared for the respective R, B, and Gb components, on the respective R, B, and Gb components at the position of the Gr pixel.

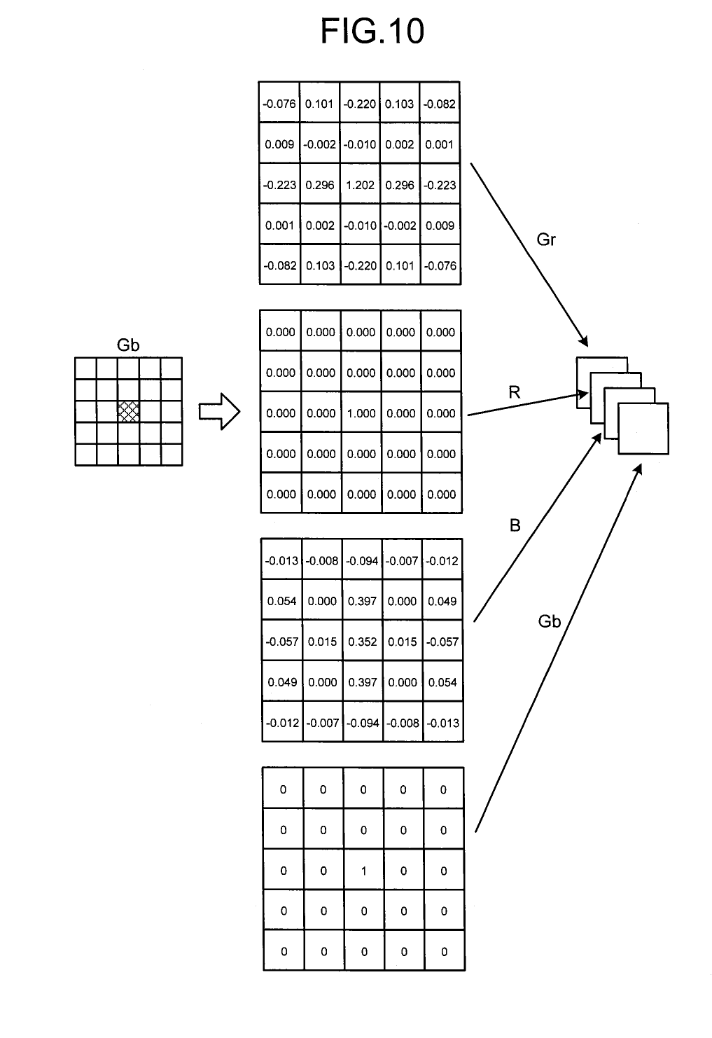

FIG. 10 is a diagram illustrating examples of conversion tables that are used to obtain signals of the respective R, B, Gr, and Gb components at the position of a Gb pixel. A Gb pixel is positioned at the center of the 5×5 pixel block. The demosaic processing unit 21 may output the signal level, which is detected by the Gb pixel, as it is, as for a signal of the Gb component at the Gb pixel. The demosaic processing unit 21 performs interpolation, which is based on the conversion tables prepared for the respective R, B, and Gr components, on the respective R, B, and Gr components at the position of the Gb pixel.

Meanwhile, the coefficients, which are elements of the respective conversion tables exemplified in this embodiment, may be appropriately changed. The conversion tables are not limited to 5×5 matrices. The conversion table may be appropriately modified according to the range or the like of a pixel block where a signal level is referred in the interpolation of each color component.

The color matrix processing unit 23 newly generates image signals (R′, G′, and B′) of three components, that is, R, B, and G components, from image signals (R, Gr, B, and Gb) of four components, that is, R, Gr, B, and Gb components by performing, for example, calculation corresponding to the following expression (1).

$$( \begin{matrix}{R}^{′} \\ {G}^{′} \\ {B}^{′}\end{matrix} ) = ( \begin{matrix}{a}_{11} & {a}_{12} & {a}_{13} & {a}_{14} \\ {a}_{21} & {a}_{22} & {a}_{23} & {a}_{24} \\ {a}_{31} & {a}_{32} & {a}_{33} & {a}_{34}\end{matrix} ) ( \begin{matrix}R \\ Gr \\ B \\ Gb\end{matrix} ) \qquad ( 1 )$$

Meanwhile, aᵢⱼ (i=1, 2, and 3 and j=1, 2, 3, and 4) is a correction coefficient. The color matrix processing unit 23 generates image signals (R′, G′, and B′) of three components, by multiplying a 3×4 color matrix by image signals (R, Gr, B, and Gb) of four components.

Correction coefficients of a 3×4 color matrix meet the conditions of Expressions (2) to (4).

a₁₁+a₁₂+a₁₃+a₁₄=1 (2)

a₂₁+a₂₂+a₂₃+a₂₄=1 (3)

a₃₁+a₃₂+a₃₃+a₃₄=1 (4)

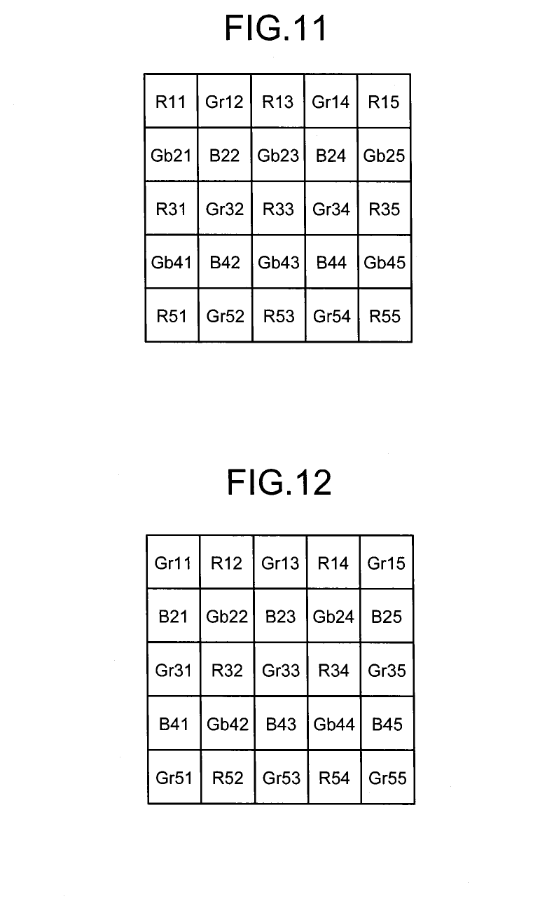

Here, the condition of each conversion table of the demosaic processing unit 21 of this embodiment will be described. FIG. 11 is a diagram illustrating a condition of the conversion table that is used to obtain a signal of each of R, B, Gr, and Gb components at the position of the R pixel. “R11”, “Gr12”, . . . mean the respective coefficients of the 5×5 conversion table. The coefficients correspond to the pixels of the 5×5 pixel block, respectively. The coefficient is multiplied by the signal level that is detected by the corresponding pixel.

The conversion table, which is used to obtain a signal of an R component, meets the condition of the following expression (5) with respect to the respective coefficients corresponding to the R pixel. Further, as illustrated in an expression (6), the sum of the respective coefficients corresponding to the B, Gr, and Gb pixels is zero.

R11+R13+R15+R31+R33+R35+R51+R53+R55=1 (5)

Gr12+Gr14+Gb21+B22+Gb23+B24+Gb25+Gr32+Gr34+Gb41+B42+Gb43+B44+Gb45+Gr52+Gr54=0 (6)

The conversion table, which is used to obtain a signal of a Gr component, meets the condition of the following expression (7) with respect to the respective coefficients corresponding to the Gr pixel. The sum of the respective coefficients corresponding to the R, B, and Gb pixels is zero. Meanwhile, the description of an expression in which each coefficient is zero will be omitted in the following description.

Gr12+Gr14+Gr32+Gr34+Gr52+Gr54=1 (7)

The conversion table, which is used to obtain a signal of a B component, meets the condition of the following expression (8) with respect to the respective coefficients corresponding to the B pixel. The sum of the respective coefficients corresponding to the R, Gr, and Gb pixels is zero.

B22+B24+B42+B44=1 (8)

The conversion table, which is used to obtain a signal of a Gb component, meets the condition of the following expression (9) with respect to the respective coefficients corresponding to the Gb pixel. The sum of the respective coefficients corresponding to the R, B, and Gr pixels is zero.

Gb21+Gb23+Gb25+Gb41+Gb43+Gb45=1 (9)

FIG. 12 is a diagram illustrating a condition of the conversion table that is used to obtain a signal of each of R, B, Gr, and Gb components at the position of a Gr pixel. “Gr11”, “R12”, . . . mean the respective coefficients of the 5×5 conversion table.

The conversion table, which is used to obtain a signal of an R component, meets the condition of the following expression (10) with respect to the respective coefficients corresponding to the R pixel. The sum of the respective coefficients corresponding to the B, Gr, and Gb pixels is zero.

R12+R14+R32+R34+R52+R54=1 (10)

The conversion table, which is used to obtain a signal of a Gr component, meets the condition of the following expression (11) with respect to the respective coefficients corresponding to the Gr pixel. The sum of the respective coefficients corresponding to the R, B, and Gb pixels is zero.

Gr11+Gr13+Gr15+Gr31+Gr33+Gr35+Gr51+Gr53+Gr55=1 (11)

The conversion table, which is used to obtain a signal of a B component, meets the condition of the following expression (12) with respect to the respective coefficients corresponding to the B pixel. The sum of the respective coefficients corresponding to the R, Gr, and Gb pixels is zero.

B21+B23+B25+B41+B43+B45=1 (12)

The conversion table, which is used to obtain a signal of a Gb component, meets the condition of the following expression (13) with respect to the respective coefficients corresponding to the Gb pixel. The sum of the respective coefficients corresponding to the R, B, and Gr pixels is zero.

Gb22+Gb24+Gb42+Gb44=1 (13)

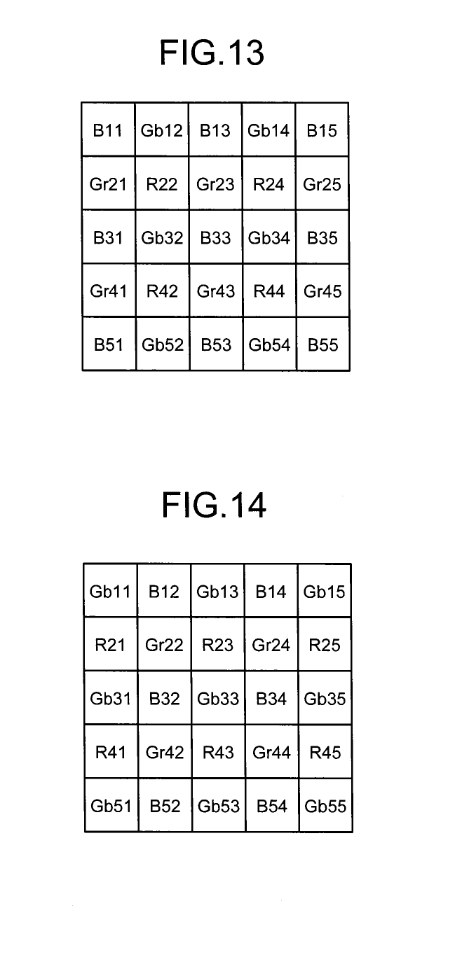

FIG. 13 is a diagram illustrating a condition of the conversion table that is used to obtain a signal of each of R, B, Gr, and Gb components at the position of a B pixel. “B11”, “Gb12”, . . . mean the respective coefficients of the 5×5 conversion table.

The conversion table, which is used to obtain a signal of an R component, meets the condition of the following expression (14) with respect to the respective coefficients corresponding to the R pixel. The sum of the respective coefficients corresponding to the B, Gr, and Gb pixels is zero.

R22+R24+R42+R44=1 (14)

The conversion table, which is used to obtain a signal of a Gr component, meets the condition of the following expression (15) with respect to the respective coefficients corresponding to the Gr pixel. The sum of the respective coefficients corresponding to the R, B, and Gb pixels is zero.

Gr21+Gr23+Gr25+Gr41+Gr43+Gr45=1 (15)

The conversion table, which is used to obtain a signal of a B component, meets the condition of the following expression (16) with respect to the respective coefficients corresponding to the B pixel. The sum of the respective coefficients corresponding to the R, Gr, and Gb pixels is zero.

B11+B13+B15+B31+B33+B35+B51+B53+B55=1 (16)

The conversion table, which is used to obtain a signal of a Gb component, meets the condition of the following expression (17) with respect to the respective coefficients corresponding to the Gb pixel. The sum of the respective coefficients corresponding to the R, B, and Gr pixels is zero.

Gb12+Gb14+Gb32+Gb34+Gb52+Gb54=1 (17)

FIG. 14 is a diagram illustrating a condition of the conversion table that is used to obtain a signal of each of R, B, Gr, and Gb components at the position of a Gb pixel. “Gb11”, “B12”, . . . mean the respective coefficients of the 5×5 conversion table.

The conversion table, which is used to obtain a signal of an R component, meets the condition of the following expression (18) with respect to the respective coefficients corresponding to the R pixel. The sum of the respective coefficients corresponding to the B, Gr, and Gb pixels is zero.

R21+R23+R25+R41+R43+R45=1 (18)

The conversion table, which is used to obtain a signal of a Gr component, meets the condition of the following expression (19) with respect to the respective coefficients corresponding to the Gr pixel. The sum of the respective coefficients corresponding to the R, B, and Gb pixels is zero.

Gr22+Gr24+Gr42+Gr44=1 (19)

The conversion table, which is used to obtain a signal of a B component, meets the condition of the following expression (20) with respect to the respective coefficients corresponding to the B pixel. The sum of the respective coefficients corresponding to the R, Gr, and Gb pixels is zero.

B12+B14+B32+B34+B52+B54=1 (20)

The conversion table, which is used to obtain a signal of a Gb component, meets the condition of the following expression (21) with respect to the respective coefficients corresponding to the Gb pixel. The sum of the respective coefficients corresponding to the R, B, and Gr pixels is zero.

Gb11+Gb13+Gb15+Gb31+Gb33+Gb35+Gb51+Gb53+Gb55=1 (21)

According to the embodiment, the image sensor 10 detects the Gr component and the Gb component of the same wavelength by the Gr pixel and the Gb pixel. On the other hand, in the calculation for the interpolation, the demosaic processing unit 21 differentiates the Gr component from the Gb component as in the case of the color components different from each other and generates image signals of four components, that is, R, B, Gr, and Gb components.

Since the Gr component and the Gb component are differentiated from each other and are dealt with in the demosaic processing as described above, the respective coefficients of the conversion table for interpolation can be arbitrarily adjusted so that a difference in sensitivity between the Gr pixel and the Gb pixel is reduced. The demosaic processing unit 21 performs interpolation on the basis of a conversion table that is set so as to include adjustment for reducing a difference in sensitivity between the Gr pixel and the Gb pixel.

Since the demosaic processing using the interpolation is performed, the ISP 6 can effectively reduce lattice-shaped luminance unevenness that is caused by a difference in sensitivity between the Gr pixel and the Gb pixel. The digital camera 1 can obtain an image having a high resolution as compared to a case in which processing for averaging a signal output from the Gr pixel and a signal output from the Gb pixel is performed.

The digital camera 1 has an effect of taking an image that has less luminance unevenness, a high resolution, and high quality.

The demosaic processing unit 21 and the color matrix processing unit 23, which have been included in the ISP 6 in this embodiment, may not be provided in the ISP 6 and may be provided in the signal processing circuit 11 of the solid-state imaging device 5. Accordingly, the solid-state imaging device 5 and the camera module 2 can take an image that has less luminance unevenness, a high resolution, and high quality. The OTP 9, which stores the conversion tables, may be provided in the solid-state imaging device 5.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A solid-state imaging device comprising:
a pixel array in which a plurality of pixels including photoelectric conversion elements is disposed in the form of an array and which shares and detects a signal level of each color light with every pixel; and
a signal processing circuit configured to perform signal processing on image signals that are output from the pixel array,
wherein the signal processing circuit includes a demosaic processing unit that performs demosaic processing for generating a signal component of each color light at the position of each pixel by interpolating signal levels detected at the respective pixels,
the pixel array is formed using a pixel block, which includes a red pixel detecting a signal level of red light, a blue pixel detecting a signal level of blue light, and first and second green pixels detecting a signal level of green light, as a unit,
a first green component detected by the first green pixel and a second green component detected by the second green pixel are green components of the same wavelength region, and
the demosaic processing unit generates image signals of four components, that is, a red component detected by the red pixel, a blue component detected by the blue pixel, the first green component, and the second green component.

2. The solid-state imaging device according to claim 1,
wherein the signal processing circuit includes a color matrix processing unit that newly generates image signals of three components, that is, a red component, a green component, and a blue component, from the image signals of the four components.

3. The solid-state imaging device according to claim 1,
wherein the demosaic processing unit interpolates signal levels, which are detected at the respective pixels, on the basis of conversion tables, and
a conversion table used to obtain the first green component is different from a conversion table used to obtain the second green component.

4. The solid-state imaging device according to claim 3,
wherein the conversion table is a matrix of which elements are coefficients to be multiplied by the signal levels of the respective pixels included in the pixel block, and
the coefficients are set so as to include adjustment of a difference in sensitivity between the first green component and the second green component.

5. The solid-state imaging device according to claim 3, further comprising:
a memory that stores the conversion tables,
wherein the memory stores sixteen conversion tables that are used to obtain image signals of the four components at the positions of the respective pixels.

6. The solid-state imaging device according to claim 1,
wherein the demosaic processing unit obtains a signal of the second green component at the position of the first green pixel by performing interpolation that is based on the conversion table prepared for the second green component at the position of the first green pixel.

7. The solid-state imaging device according to claim 1,
wherein the demosaic processing unit obtains a signal of the first green component at the position of the second green pixel by performing interpolation that is based on the conversion table prepared for the first green component at the position of the second green pixel.

8. The solid-state imaging device according to claim 1,
wherein the demosaic processing unit obtains a signal of each of the first and second green components at the position of the red pixel by performing interpolation that is based on the conversion tables prepared for the respective first and second green components at the position of the red pixel.

9. The solid-state imaging device according to claim 1,
wherein the demosaic processing unit obtains a signal of each of the first and second green components at the position of the blue pixel by performing interpolation that is based on the conversion tables prepared for the respective first and second green components at the position of the blue pixel.

10. The solid-state imaging device according to claim 1, further comprising:
color filters that are provided on incident sides of the respective pixels of the pixel array,
wherein the color filter provided on the incident side of the first green pixel and the color filter provided on the incident side of the second green pixel have wavelength characteristics of transmitting the green components of the same wavelength region.

11. A digital camera comprising:
a camera module that includes an imaging optical system receiving light from an object and forming an image of the object, and a solid-state imaging device taking the image of the object; and
a processor that controls the camera module,
wherein the solid-state imaging device includes a pixel array in which a plurality of pixels including photoelectric conversion elements is disposed in the form of an array and which shares and detects a signal level of each color light with every pixel,
the processor includes a demosaic processing unit that performs demosaic processing for generating a signal component of each color light at the position of each pixel by interpolating signal levels detected at the respective pixels,
the pixel array is formed using a pixel block, which includes a red pixel detecting a signal level of red light, a blue pixel detecting a signal level of blue light, and first and second green pixels detecting a signal level of green light, as a unit,
a first green component detected by the first green pixel and a second green component detected by the second green pixel are green components of the same wavelength region, and
the demosaic processing unit generates image signals of four components, that is, a red component detected by the red pixel, a blue component detected by the blue pixel, the first green component, and the second green component.

12. The digital camera according to claim 11,
wherein the processor includes a color matrix processing unit that newly generates image signals of three components, that is, a red component, a green component, and a blue component, from the image signals of the four components.

13. The digital camera according to claim 11,
wherein the demosaic processing unit interpolates signal levels, which are detected at the respective pixels, on the basis of conversion tables, and
a conversion table used to obtain the first green component is different from a conversion table used to obtain the second green component.

14. The digital camera according to claim 13,
wherein the conversion table is a matrix of which elements are coefficients to be multiplied by the signal levels of the respective pixels included in the pixel block, and
the coefficients are set so as to include adjustment of a difference in sensitivity between the first green component and the second green component.

15. The digital camera according to claim 13, further comprising:
a memory that stores the conversion tables,
wherein the memory stores sixteen conversion tables that are used to obtain image signals of the four components at the positions of the respective pixels.

16. The digital camera according to claim 11,
wherein the demosaic processing unit obtains a signal of the second green component at the position of the first green pixel by performing interpolation that is based on the conversion table prepared for the second green component at the position of the first green pixel.

17. The digital camera according to claim 11,
wherein the demosaic processing unit obtains a signal of the first green component at the position of the second green pixel by performing interpolation that is based on the conversion table prepared for the first green component at the position of the second green pixel.

18. The digital camera according to claim 11,
wherein the demosaic processing unit obtains a signal of each of the first and second green components at the position of the red pixel by performing interpolation that is based on the conversion tables prepared for the respective first and second green components at the position of the red pixel.

19. The digital camera according to claim 11,
wherein the demosaic processing unit obtains a signal of each of the first and second green components at the position of the blue pixel by performing interpolation that is based on the conversion tables prepared for the respective first and second green components at the position of the blue pixel.

20. The digital camera according to claim 11,
wherein the solid-state imaging device includes color filters that are provided on incident sides of the respective pixels of the pixel array, and
the color filter provided on the incident side of the first green pixel and the color filter provided on the incident side of the second green pixel have wavelength characteristics of transmitting the green components of the same wavelength region.
